(19) United States
(12) Patent Application Publication
(10) Pub. No.: US 2004/0243362 A1
(43) Pub. Date: Dec. 2, 2004

(54) Information processing method for disease stratification and assessment of disease progressing

(76) Inventor: Michael N. Liebman, Paoli, PA (US)

Correspondence Address: FOLEY AND LARDNER, SUITE 500, 3000 K STREET NW, WASHINGTON, DC, 20007, US

(21) Appl. No.: 10/479,192

(22) PCT Filed: May 31, 2002
(86) PCT No.: PCT/US02/17015

Related U.S. Application Data
(60) Provisional application No. 60/294,638, filed on Jun. 1, 2001.

(51) Int. Cl. G06F 7/60

(52) U.S. Cl. 703/2

(57) ABSTRACT

A digital computer system stratifies in a set of patients, based on a set of observations. The observations can include physical, biochemical, histological, genetic, and gene-expression data, among other types of information. Adjustments can be made to account for the possibility that observations of several patients may begin at different points in the progression of their respective disease processes. Once these adjustments are made, the data are subjected to a statistical cluster analysis. Each cluster of patients potentially represents a different disease stratum, with its own underlying cause, optimum therapy, and prognosis. Once the strata are defined and patients are assigned to them, adjustments to the data can be refined. The cluster analysis then can be repeated, and so an iterative process of stratification and staging takes place.

### CROSS REFERENCE TO RELATED APPLICATIONS

The application claims priority to U.S. Provisional Patent Application Ser. No. 60/294,638 filed on Jun. 1, 2001.

### BACKGROUND OF THE INVENTION

1. Field of the Invention

This invention relates generally to the field of disease stratification which can be used in predictive medicine to assess disease progression in response to certain factors when taking into consideration a particular patient's biological and genetic background.

2. Description of the Related Art

Modem medicine makes use of disease-specific knowledge to: (a) select the best and most cost-effective therapy for an individual patient; and (b) guide the development of: (i) the next generation of diagnostics, (ii) therapeutic drugs, (iii) health-care products, and (iv) lifestyle recommendations. Knowledge about a particular patient is derived from observations of that patient. These observations may include family history, findings from a physical examination, blood and urine test results, imaging studies such as MRI and CT, and the like; genetic information is also being obtained more frequently. In addition, gene-expression and protein-expression data from microarray technology will soon be available for clinical use.

Increasingly, traditional disease classifications are being subdivided into categories according to the mechanism or gene responsible, even though all categories produce the same symptoms. This subdividing process is known as “disease stratification.” Stratification can be used to select the most appropriate diagnostic and therapeutic course for a patient, and to predict outcomes. It can also be used to define appropriate stratum-specific targets for drug development. Generally, stratification has been based on: (a) a single salient biochemical marker; (b) obvious differences in response to current therapy; or (c) differences in particular genes.

One of the main reasons for obtaining diagnostic information is to determine the stage of progression of a patient's disease. This information is critical to determining the appropriate therapy for the disease. In the case of cancer, the stage of the disease will determine whether surgery, radiation therapy, chemotherapy, or a combination of the above is most appropriate, and will further determine the exact approach to each. In the case of kidney disease, the stage of disease will determine whether the disease is best treated with medicine, diet and lifestyle changes, or whether dialysis and transplantation need to be considered. By way of another example, staging and evaluation of postmenopausal osteoporosis can be used to balance the benefits of hormone replacement therapy against the risks of adverse effects from estrogen use.

At the current state of clinical practice, both stratification and staging involve ambiguity and overlap. Single-disease markers fail to give a complete picture of disease progression. In assessing diabetes, for example, both glucose and Hemoglobin A1c are measured; one gives a short-term measurement while the other assesses long-term glycemic control.

Ambiguities may arise in how to stage a particular patient, depending on which markers of disease progression are used. Moreover, the defined stages of the disease may overlap. Accordingly, better methods are needed to determine (a) the disease path on which a patient is located and (b) where the patient is along that path.

U.S. Pat. No. 5,657,255 describes a biological modeling system that could conceivably be used to create a model of disease progression. The model disclosed in the '255 patent requires a mathematical model of all variables that are to be observed. The theory and mechanism of the disease must be fully described to create such a disease model. In clinical practice, however, such complete models are rarely available, if ever. U.S. Pat. No. 6,108,635 concerns an “Integrated Disease Information System” that may be used to explore disease progression. However; the system in question involves a human operator at each stage in the assessment of disease progression.

Accordingly, there is a need to stratify and stage disease in such a manner that does not require detailed models of the internal mechanisms underlying the disease. Moreover, in satisfying this need, it would be preferable to be able to determine the stratum and stage of disease in an automated fashion. Further, it would be beneficial to be able to stratify diseases based on less-obvious but significant criteria, such as characteristic combinations of multiple biochemical markers, subtle differences in therapeutic response, or combinations of multiple genetic loci. In addition, the stratification should be reflective of the shape of the time course of multiple variables such as biochemical markers or clinical signs.

Clearly, there is a need to be able to identify diagnostic markers that may be used to predict or determine to which of the disease strata (each of which reflects a different time progression of the same disease) a particular patient belongs. It follows that, in order to make these predictions or determinations, there is a need to determine the earliest point in time at which a given diagnostic marker may be applied. It may be desirable to incorporate such markers into future clinical trials for the disease under study, as well as for other diseases. In consideration of the varying disease strata of a particular disease, there is a need to be able to resolve ambiguities among various measures of a disease that are used for staging purposes.

### SUMMARY OF THE INVENTION

A solution to one or more of the previously described deficiencies can be achieved by an information processing method which can stratify a disease and predict its progression. The method described below which is capable of such stratification and progression and does so without requiring detailed models of the internal mechanisms underlying the disease. In addition, the stratification can be determined based on less-obvious but significant criteria, such as characteristic combinations of multiple biochemical markers, subtle differences in therapeutic response, or combinations of multiple genetic loci. Further, the model is able to determine the stratum and stage of disease in an automated fashion.

One information processing method for disease stratification and the assessment of disease progression, as set forth in greater detail below, includes recording a time series of observations of variables regarding a plurality of patients who share a given disease. To have a better and more useful model, the particular set of patients must reflect a reasonably common background such as being “adults” or being “untreated.” Accordingly, a group of such patients must be selected from the entire universe of patients based on patient demographic information or history of prior treatment. Although the variables which may be observed are not limited to any particular class, they may include demographic data, biochemical data, pathologic data, histological data, genetic data, or gene-expression data, or any combination thereof. The observations are entered and stored as a data set in a digital computer system, which performs subsequent steps as automated computations. Although the initial strata may be provided by a clinician or a published clinical disease-staging algorithm, preferably the computer stratifies the disease under study by clustering patients into strata; the strata are based on the shapes of the curves which represent the progression of the measured observations over time.

Using this stratification (and a subsequent reiteration of the stratification model, if the original stratification is found to be inaccurate), the strata are aligned, truncated, or extended so that like time progressions substantially overlap. At this point, for each pair of patients, the computer compares the aligned time progressions to determine a measure of the mathematical distance between them. There are a number of ways to measure the mathematical distance between time progressions including point-wise calculations using a Euclidean metric, city-block metric, or manually-prepared lookup table. The stratification is refined by assigning patients to clusters based on the mathematical distances between the strata so that each cluster corresponds to a particular stratum of the disease; the cluster assignments may be interactively modified by a human operator. Finally, the stratification model may be refined until the progression and stratification estimates do not change appreciably with each subsequent iteration.

The disease stratification and progression information can be combined with genetic data, gene expression data, or biochemical data, to identify a biochemical target for drug development as therapy for a particular stratum or set of strata of the disease under study. Alternatively, the information can be used to determine lifestyle factors that are correlated with improved outcomes for a particular stratum (or set of strata) of the disease under study, so as to recommend lifestyle changes to a cohort of patients in a particular stratum or strata.

In the previously described method, various optional steps can be employed to enhance the accuracy and/or simplicity of the model. For instance, the rate of change of some or all variables with respect to time for each patient can be calculated; the data files corresponding to those patients can be augmented to reflect the results of these calculations. In addition, to simplify the resultant model, the number of variables used in the model may be reduced based on subsequent analyses through a dimensionality-reduction technique (which may be a principal-components analysis or a factor analysis) which eliminates or combines variables that add relatively little information to the data set.

Based on the previously described method, a clinician may determine which observed variable or variables provide the most information regarding the stratification. With this determination, a researcher or a clinician could develop a diagnostic marker kit for stratification of the disease under study. In addition, by analogy to other patients at a similar stage in the same disease stratum, the disease stratification and progression information may be used to predict the course of an individual patient's disease. The disease stratification and progression information for the particular patient may be submitted to a clinician for a determination of the best course of treatment for that patient based on the clinician's diagnosis upon determining how that patient fits in the disease stratification and progression model (i.e., on which stratum that patient falls and where the patient currently is along that stratum).

Where a model has been effectuated based on the previously described information processing method for disease stratification and assessment of disease progression, a clinician may record a time series of observations of variables regarding an additional patient or plurality of patients who share the disease which is represented by the model. By entering and storing these additional observations as a data set in a digital computer system, the model can be revised and thereby improved. In addition, the clinician may estimate the stage of progression of each additional patient's disease at the time of the first observation for that patient.

For each of these additional patients, a clinician may calculate the rate of change of some or all of the variables with respect to time; moreover, the data set may be augmented to reflect these calculations. Using the stratification model (and a subsequent reiteration of the stratification model, if the original stratification is later found to be inaccurate), the additional patients' time progressions may be aligned, truncated, or extended so that they substantially overlap like strata previously known to the model. At this point, for each patient, the computer may then compare the aligned time progressions to determine a measure of the mathematical distance between them. Each of the additional patients may then be assigned to a cluster based on the determined mathematical distances between them. In this fashion, the additional patients are assigned to a particular stratum of the disease. In addition, the clinician may determine the distances between the patients within a particular cluster. Finally, based on the allocation of an additional patient to a particular cluster (and, thereby, to a particular disease stratum), the clinician may revise an earlier estimate of the stage of progression of that patient's disease made at the time of the first observation for that patient.

A better understanding of the information processing method for disease stratification and assessment of disease progression will be easier to appreciate when considering the detailed description in light of the figures described below.

### BRIEF DESCRIPTION OF THE DRAWINGS

The accompanying drawings, which are incorporated in and constitute a part of the specification, illustrate an embodiment of the invention and together with the description, serve to explain the principles of the invention.

FIG. 1, which is a flow diagram of the current treatment protocol for kidney disease, shows how approximately forty distinct diseases lead to end stage renal disease which is then currently treated by dialysis and possibly further by kidney transplant;

FIG. 2(a) is a plot of tumor size versus time for one genotype of a particular type of cancer; FIG. 2(b) is a plot of tumor size versus time for another genotype of the same cancer shown in FIG. 2(a);

FIG. 3(a) is a plot of a first patient's tumor growth versus time; FIG. 3(b) is a plot of a second patient's tumor growth versus time; FIG. 3(c) is a plot of a third patient's tumor growth versus time; FIG. 3(d) is a plot of a fourth patient's tumor growth versus time, it is to be understood that the patients in FIGS. 3(a)-3(d) have the same general type of cancer although they may have different forms of it;

FIG. 4(a) depicts the tumor growth plots for the four patients represented in FIGS. 3(a)-3(d) when plotted over the same time course; FIG. 4(b), which depicts the curves of FIG. 4(a) realigned, shows that two of the patients in FIGS. 3(a)-3(d) likely share one genotype of the disease represented by one stratum of disease progression whereas the other two patients in FIGS. 3(a)-3(d) likely share a different genotype of the disease represented by a different stratum;

FIG. 5 is a flowchart representing the formulation of a model based on the measured time dependent data which is used to determine a particular disease's strata;

FIG. 6 shows a plot of a stratum for Hemoglobin A1C, entitled “HBAL1C;”

FIG. 7 shows a plot of a stratum for Retinopathy, entitled ETDRS;

FIG. 8 shows a plot of a stratum for Motor Nerve Velocity; and

FIG. 9 shows a plot of a stratum for Sensory Nerve Velocity.

### DETAILED DESCRIPTION OF THE PREFERRED EMBODIMENT

Reference will now be made in detail to a presently preferred embodiment of the invention, which is illustrated in the drawings. The present invention comprehends a model of disease progression that is based entirely on the data provided. The approach of the invention does not require input regarding the underlying theory or mechanisms of the disease.

The present invention employs clinical observations of patients or other organisms as the basis for stratification and staging. The observations are stored and processed in a digital computer system. Some or all of the observations, from some or all of the patients, may be processed at once. The data are subjected to the statistical procedure known as. “cluster analysis,” which groups patients together based on the shape of the curves representing changes in observed variables over time. Each cluster of patients potentially represents a different disease stratum. Adjustments are made to account for the fact that observations of different patients begin at different points in the progression of their respective disease processes. These adjustments can be used to determine the stage of disease progression for each individual patient within their disease stratum. Once the strata and stages are initially defined, the cluster analysis and adjustments can be repeated, so that a convergent, iterative process of stratification and staging takes place.

The present invention stratifies diseases based on observations of patients. The term “stratification” refers to the identification of subsets within what has been traditionally known as a single disease, such as breast cancer. A “patient” typically refers to a human individual affected by a disease, but it encompasses animals and even plants that are subject to disease processes. Uses of stratification include: (a) identifying molecules which are targets for the development of therapeutic drugs, aimed at a particular disease stratum; (b) selecting optimum therapy, which may include drugs and/or lifestyle changes, based on a particular stratum; (c) selecting diagnostic tests based on a particular stratum; or (d) predicting the course of disease based on the stratum into which that patient falls.

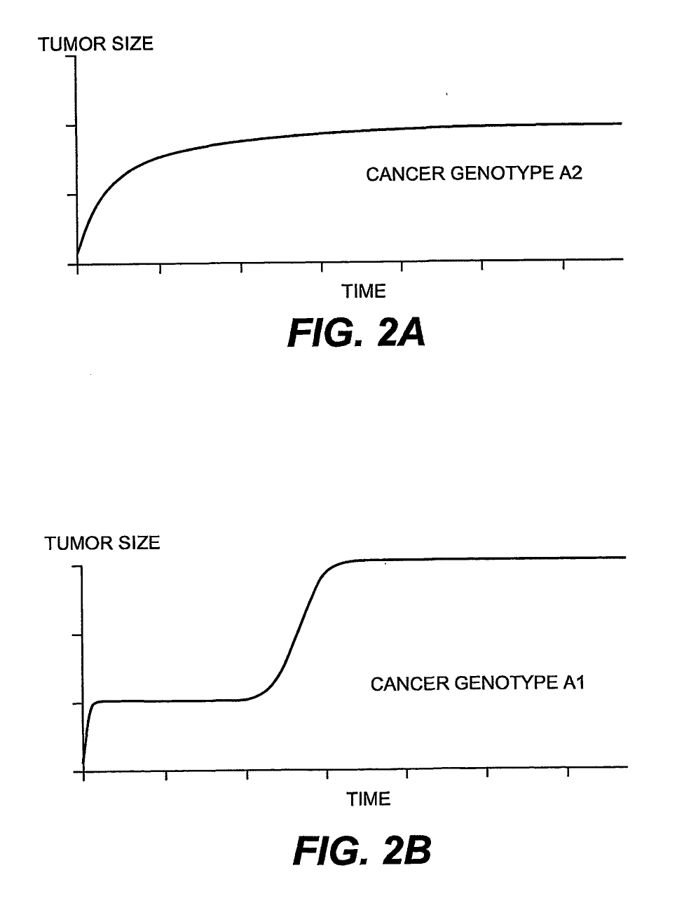

As a hypothetical example, FIGS. 2(a) and 2(b) show plot of a tumor growth over time for two different genotypes of cancer. Tumor size is associated with the severity of the disease. Genotype A1 and Genotype A2 may clinically appear to be the same disease, but they follow different time courses. By analyzing data from a large number of patients over time, the present invention can assist the clinician and researcher in distinguishing between these two distinct forms of cancer, which may in fact respond to different kinds of treatment. For simplicity, a single disease-associated variable, tumor size, is shown. In an actual application, the distinctions between Genotype A1 and Genotype A2 might not be apparent unless several additional variables, such as cell DNA content and expression of various genes, are examined in a high-dimensional space.

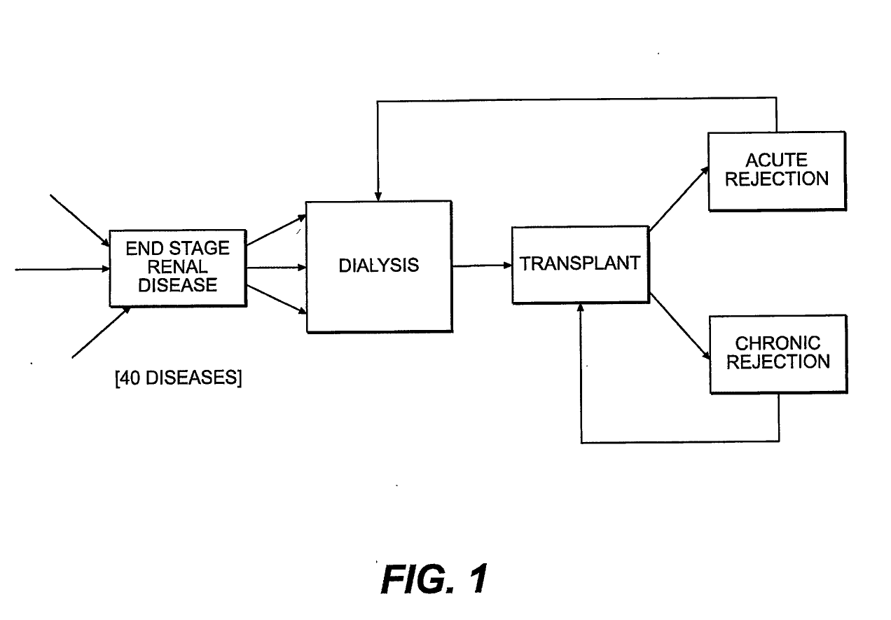

The present invention also determines the stage of progression of a patient's disease, based on an analysis of observations of the patient. Diseases tend to progress through a series of stages over time, particularly if untreated. Treatment may modify the order of progression, or may alter the amount of time spent in each stage of the disease process. FIG. 1 shows an example of the stages of renal disease leading to kidney failure and transplant. Any one of a large number of medical conditions can bring a patient into a state of end-stage renal disease, in which the kidneys are no longer competent to filter waste products from the bloodstream.

The patient will then be placed on dialysis. A number of dialysis patients will go on to receive kidney transplants. Some of these will suffer acute rejection and loss of the kidney due to the immune response. Others will suffer effects from chronic rejection, but will eventually be able to maintain some state of health with the transplanted kidney. While FIG. 1 illustrates disease stages as discrete steps, other diseases progress on a continuous basis, and the distinction between stages (e.g., tumors staged as I, II, III, etc.) is not a natural division, but rather a convenience for the clinician and researcher.

It is important that each patient be observed periodically over time. If observations are not made at several points in time, one cannot tell, for instance, if a patient is being seen early in the course of a severe disease, or later in the course of a milder one. The observations of each patient may consist of any of the items that might enter a patient's medical file. Results of a family history and physical examination may be included, along with laboratory test results from blood, urine, or other specimens. Imaging studies such as MRI may be included. Special tests such as electrocardiograms or pulmonary-function tests may be included. Results of histological/pathological examination of specimens may be included as well. Results of genetic testing may be included, and are expected to fulfill an important role in the future. Data from DNA microarrays may be included to measure gene expression in patient tissues of importance. Data from newer microarray technology may measure protein expression as well. The date of observation may be recorded, along with the observation itself. It is desirable that observations cover the entire time course of the disease, including the time period prior to the appearance of the first symptoms.

In all cases, these data should be obtained in or converted into a form that will permit two observations to be compared in a numerical fashion, in order to determine a “distance” between them. For verbal descriptions such as in the physical exam, this can be accomplished with a controlled vocabulary and numerical coding. For example “The patient appears well” could be coded as a “5,” with “The patient appears acutely ill” as a “3,” and “The patient is comatose” as a “1.” For imaging studies, it may be necessary to measure features within the image, such as the diameter of tumors. More subjective features, such as pulmonary infiltrates in a chest X-ray, could, for example, be rated by clinicians on a scale of 0/+ to ++++, coded by the numbers 0 to 4. Presence or absence of genes may be coded as 0 or 1. Multiple possible alleles of a given gene may each be given a particular code. An “observation” refers to a single number, or description that can be converted to a number, associated with a particular patient at a particular time. A “variable” is an aspect of the patient that may be observed, such as blood pressure, tumor diameter, serum creatinine level, or the expression level of a particular gene.

In general, a patient may have more than one disease, and multiple diseases may interact. A given disease may be characterized by one or more observations, or by a measure of disease progression derived from those observations. This includes disease-progression measures derived from the present invention. Such measures may fill the role of “observations” in the investigation of a second disease present in the same patient. Thus, the present invention may be generalized so that it can be used to study more than one disease at a time in a particular patient population.

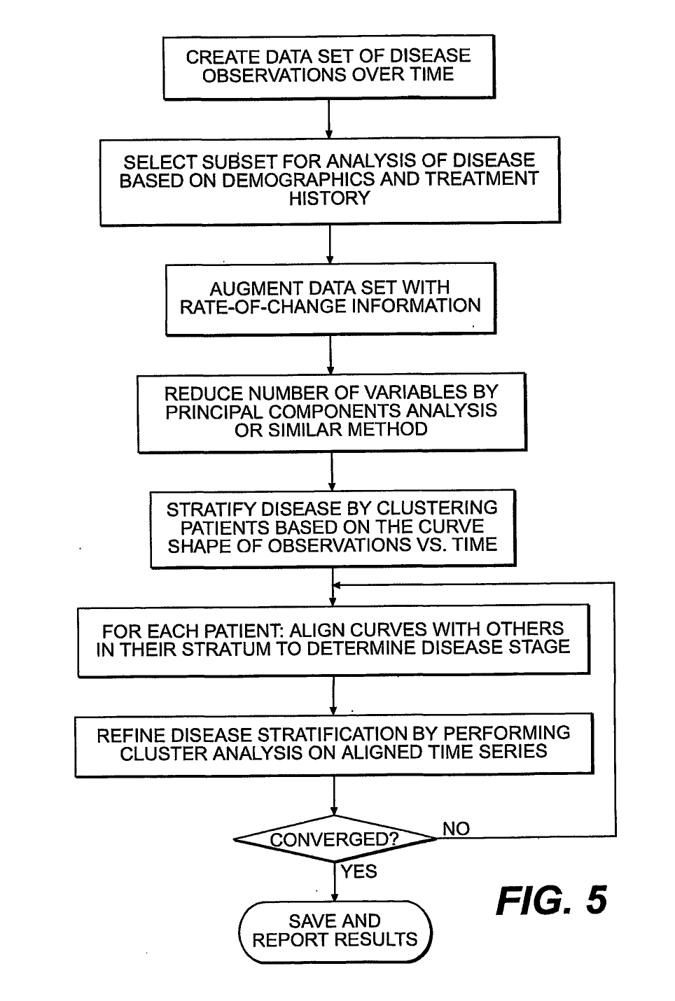

FIG. 5 shows a flowchart of the analysis process. Observations are stored in a digital computer system. The observations may be entered manually via a keyboard, or may be transferred from another computer such as a Laboratory Information Management System (LIMS), electronic medical record, or genetic analysis system.

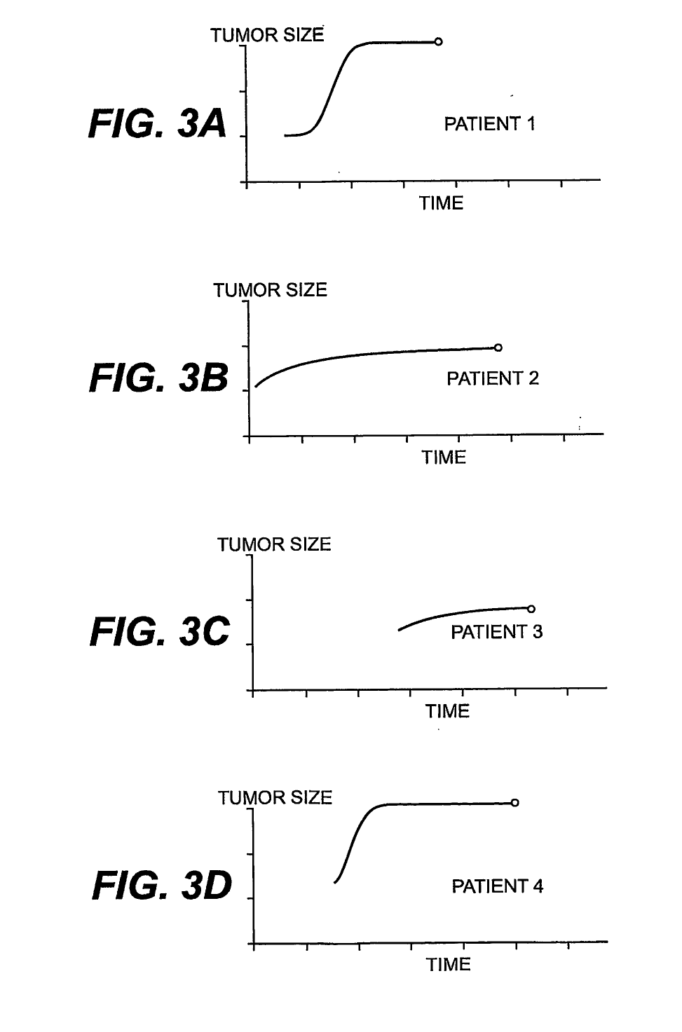

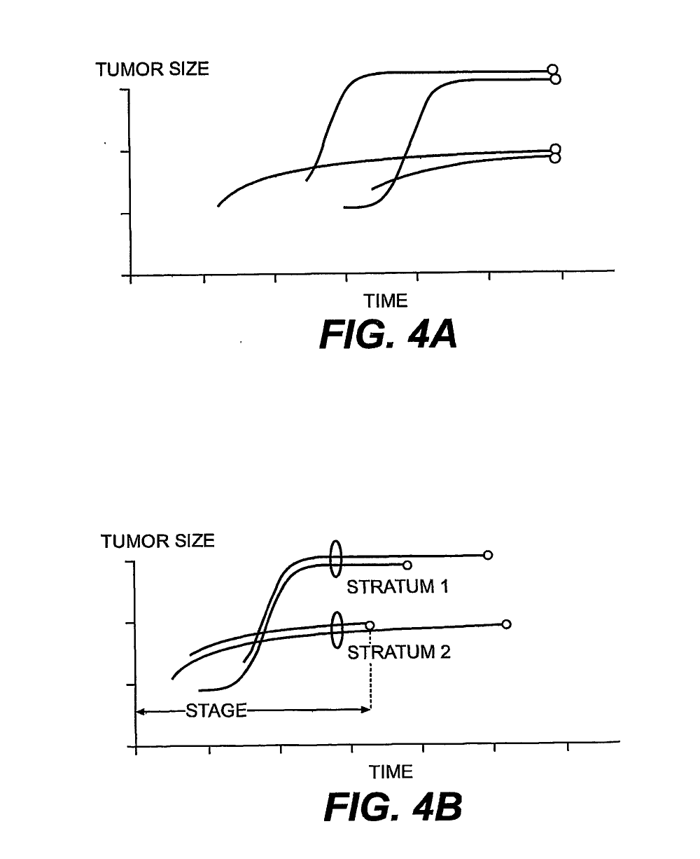

While “staging” of diseases is generally thought of in discrete terms (e.g., “Stage I,” “Stage II,” “Stage III,” etc.), for purposes of this invention, the stage of disease is generally a continuous numerical value. These continuous staging estimates can be derived by shifting the patient time series with respect to one another within each stratum so that they are aligned. FIG. 4(a) shows that if the patient data series shown in FIGS. 3(a)-(d) are aligned in “real time,” they cannot be directly compared against one another, because they are not aligned in terms of the stage of the disease process.

Once the time series are aligned, the next goal is to stratify the disease by clustering patients together who have similar time courses. This process begins with the creation of a “distance matrix,” as known to one skilled in the art of statistics, particularly cluster analysis. A triangular matrix of distances among all pairs of patients must be computed. Each interpatient distance will be a function of individual distances calculated for each variable. The function would take the form of a sum or weighted sum. The distances for a given variable would be, in turn, a sum of distances between individual observations for that variable. This sum also may be weighted.

In conventional clustering, one typically works from a distance matrix, which lists the similarity of every object to be clustered versus every other object. Conventionally, this distance matrix is computed once at the start, and then used during the clustering process. However, time shifts inherent in the date cause the distance matrix to vary dynamically as the clusters are formed. This simply means that part of the distance matrix must be updated whenever a cluster is formed.

Distances between observations may be measured in several ways. In cluster analysis, absolute differences or squared differences are often used for numerical variables. In some cases, such as numerically-encoded gene alleles, it may be desirable to manually create a lookup table to evaluate the “distance” between any two possible observations.

For the stratification and staging process to be effective, it may be necessary to restrict the population of patients for which the analysis is carried out. For example, it would not be meaningfil to compare certain variables observed in babies with the same variables in adults, even if they share the same disease. Also, it will be necessary to ensure that a single analysis does not include a mix of patients who have been subjected to widely varying therapeutic interventions. Otherwise, the method will likely create false “strata” consisting of treated patients in one stratum, and untreated patients in another. Thus, the invention includes a step of specifying criteria in terms of patient demographics (age, height, weight, sex, etc.) and treatment history. Only those patients who meet the specified criteria will be included in subsequent analysis. The criteria used to select patients will differ from one disease to another.

For purposes of subsequent cluster analysis, it will generally be desirable to include the rate of change of variables with respect to time. There are many published algorithms for calculating the derivatives of a time series. Some of these incorporate multi-point filtering so as not to unduly amplify noise in the data. These algorithms, such as Savitsky-Golay filters, may be useful in connection with the present invention.

For each patient, a time series, including data points for what may be a relatively large number of variables, is present in the data set. In such circumstances, it is generally found that a number of variables are highly correlated with one another. Thus, there may be “extra” variables that carry little significant information. Neural networks and statistical techniques, such as principal components analysis and factor analysis, may be used to reduce the number of variables carried forward into the calculation. Parenthetically, these techniques can have the added advantage that they give insight into the relationships among the variables being studied, and can reduce the number of variables needed for future studies.

The iterative process of disease stratification and staging begins by clustering the patients. Each patient has a number of time-dependent measurements associated with him or her which define a time progression (also called a time series). Each time progression describes a curve corresponding to the observed variable measurements over time. The initial clustering is based on the shape of these curves. Clustering must be based on curve shape rather than on a direct distance measure between the curves, because observations for each patient begin at a different point in time along the course of that patient's disease process (i.e., the calendar date of the observation gives no indication as to how far a patient's disease has progressed). Except in special cases, such as accidental laboratory infection, one does not generally know when “time zero” is. As the computer analyzes the entire time course of a disease, it distinguishes between a patient who is in the early stages of a severe disease from a patient who is in the later stages of a milder one (since the curve shapes will generally be different in the two cases).

Clustering of curve shapes can be accomplished by any of several time progression alignment algorithms. Any conventional clustering algorithm may be used to do the stratification. There are many such algorithms, such as “Single Linkage,” “Complete Linkage,” “K” means, “Ward's Method,” or the “Centroid Method.” These algorithms would be well-known to anyone familiar with the data analysis art, and are available in standard statistical packages such as SAS and SPSS. These algorithms group like objects together, and keep unlike objects in separate groups. As an initial step, a Savitsky-Golay filter or similar formula can be used to calculate time derivatives for the values forming the curve, thereby eliminating the effect of any constant offset from one curve to another, while also emphasizing curvature and other shape-defining features. The curves can then be aligned with respect to one another by an algorithm such as dynamic programming or wavelet transforms. Each cluster may represent a stratum of disease. It may be desirable for a human operator to split or merge clusters, after examining the data in detail, to obtain the most clinically-meaningful disease stratification.

We start with each patient in a separate stratum, then let the clustering algorithm agglomerate these strata. The strata are time-shifted with respect to one another when combined, to account for the fact that a patient is almost never observed a “time zero” of the disease process. Further, each patient (or stratum) has a first observation at a different point in the disease process. The appropriate amount of time shift can be determined either iteratively (a range of possible shift amounts is applied and the one that gives the best fit to a mathematical model is chosen) or analytically (least-squares equations are solved, based on the models themselves, to find the best time-shift).

When combining strata, we next find a “consensus” time shift that gives an acceptable fit for all of the disease variables measured. Finally, the combined strata are fit to an overall mathematical model which is subsequently re-tested to ensure an acceptable fit. Without retesting the model, it is conceivable that the model would represent a long “daisy chain” of patients, strung together in time, in a way that would not represent any plausible disease process.

Within each stratum, the time series for each patient may be further aligned in time to reduce the mean inter-patient distances. The amount of shift required to bring the time series into alignment can be used directly to update the estimate of the patient's current disease stage. This is equivalent to estimating the calendar date of “time zero” for that patient. The cluster analysis can then be repeated. This iterative process will generally converge. At the end, the clusters will represent disease strata, and the amounts of shifting applied to each patient's data, along with the observations as the final time point, indicate the stage of progression of each patient's disease. FIG. 4(b) shows the result of this analysis process. The data are aligned by disease stage, and can therefore be clustered into strata representing subsets of the disease under study. The distance from the time origin to the open circle is a measure of the disease stage, or progression, for each patient.

In summary, the synchronization and stratification uses a three-step process of clustering, where, to combine a pair of strata one: (1) determines a best time-shift for each variable; (2) determines a consensus time-shift for all variables together; (3) fits the combined, shifted data to a model; and (4) accepts the combined stratum as valid if the fit is acceptable upon re-testing the model.

An approach to assist in the synchronization of patient time course events may include those described in Prestrelski et al., Proteins 14: 430-39, 440-50 (1992). Prestrelski sets forth a method which enables the alignment and synchronization of discretely measured features and permit determination and compensation for gaps in the measurement variable, using dynamic programming methods.

In the examples of the Prestrelski articles, the time domain at varying points, which may or may not be coordinated in sampling or synchronization, was not sampled. Rather, the equivalent domain was defined as the position, within an amino acid sequence, which could be similarly numbered in a manner which may be non-identical. The position was chosen as the domain because of the presence of gaps or insertions within the linear axis or at the beginning of the axis coordinate.

An example of the application to stratification and clustering in disease analysis can be seen in the application to the examination of a database of heart transplant recipients and donors. In such a study, there is a great deal of information concerning the recipient both pre- and post-transplant, and minimal information concerning the donor pre-transplant and none post-transplant. A desired outcome of such analysis would be to determine the potential for enhancing the criteria used to match donors and recipients to enable greater success in the transplant procedure, i.e., survival of the recipient with a transplanted heart. The standard of care requires tissue typing and matching. Additional algorithms, based on the potential matching of donors with recipients of lesser body mass, have been implemented with the expectation that the heart (which is comprised of muscle) would be more likely to survive any atrophy occurring during the transplant and more successful in a smaller recipient. Analysis of this data would normally focus on predicting survival versus non-survival which could be represented by a 1 and 0, respectively.

Application of the dynamic programming analysis described in the Prestrelski et al. articles enables the donor weight to recipient weight factor to be further refined to incorporate the fact that recipients are typically physically compromised at time of transplant and their actual weight will be below their ideal weight, which more closely reflects the desired organ functional profile. In addition, the donor may, by virtue of being overweight or in poor physical shape, be significantly higher than their ideal weight; dependence on the simple actual weight ratios may not incorporate the “quality” of the donated material adequately. Further, analysis of the survival/non-survival state indicated that this simple classifier was inadequate to represent: (a) the actual desired outcome (which was length of survival); and (b) the potential ability of standard of care procedures to evaluate this adequately post-transplant. Conversion of the scoring of the patients to reflect length of time with successful transplant survival: (a) enabled the progression of transplant success or failure to be more accurately determined; (b) enabled the identification of several specific clusters of progression (in time) which could be related to causative factors that could be anticipated and corrected prior to the procedure; and (c) evaluated the potential utility of the standard of care post-transplant. Accordingly, laboratory tests were successful in warning of potential risks for organ failure or rejection.

FIGS. 3(a)-(d) show the time course of tumor growth for four patients (continuing the hypothetical cancer example set forth in FIGS. 2(a) and 2(b)). The graphed lines in each figure begin with the first measurement taken on the patient corresponding to each of those figures. In general, patients will seek medical care at different points in the progression of their cancer, when symptoms first appear. Thus, no data are available to cover the pre-symptomatic period, even though the tumor exists and is growing during that time. The open circle represents the date of the latest (most current) measurement for each patient.

Stratification and staging data can then be used for the development of diagnostics, therapeutics, and lifestyle guidelines, and can be used to predict disease outcome and optimize therapy for a particular patient. Once the full analysis has been performed on an adequate set of patients, it is much simpler to stratify and stage disease for a new additional patient. The new patient's observations can be simply aligned and clustered for a best fit to the existing data set. In addition, new observations based on new technologies or methodologies such as clinical, biological, genetic, etc. can be incorporated into the stratification process at any time. The alignment will indicate the disease stage previously described, and the cluster assignment will indicate the stratum to which the patient belongs. Moreover, the model can be updated to reflect the new patient; in this fashion the accuracy of the model can be continuously improved over time.

To elucidate the conceptual description of the invention, an explanation of the method by which the foregoing is accomplished will now be set forth by describing, in detail, a process for stratification and synchronization of patient data to form a disease model.

Preliminarily, inputs for the model must be defined. The input to the disease modeling process is a set of observations over time, made on a set of N patients, designated i=1 . . . N. There are M different clinical variables which are observed, and these are designated j=1 . . . M. Each variable is observed for each patient at a time designated by t. The number of observations, which may vary among the N patients, for each patient are indexed by k=1 . . . nᵢ. In general, the values of t may differ from patient to patient, and from variable to variable. Thus, the observations consists of an ordered set of pairs {tᵢⱼₖ, yᵢⱼₖ}, i=1 . . . N, j=1 . . . M, k=1 . . . nᵢ. where for each time t (and for each patient N), there is a corresponding measurement y for each variable M.

A first output of the disease modeling process is designed and intended to partition the patient population into strata, or clusters. Each stratum represents a pattern in the way that a prototypical “model patient” can progress through a disease. In other words, members of a given stratum share a similar pattern in the way that their observed disease variables evolve over time.

Depending on the particular clustering algorithm used, a given patient may appear to fall into more than one stratum. For example, this can happen if the patient is only observed early in the course of their disease, and there is not enough information to fully determine to which stratum the patient belongs. It could also happen if the observations occur late in the disease process, and it cannot determined by which path the patient got there.

A second output of the disease modeling process is a set of model functions for each variable and for each stratum. These model functions describe the pattern by which each variable can be expected to evolve over time for a patient who is a member of the given stratum. A third output of the disease-modeling process is a set of time-offset values, one for each instance where a patient is a member of a stratum. The time offset values are determined such that they shift the data for the given patient in time to give the best fit (in a least-squares sense) of the patient's observed data to the corresponding model functions for the stratum. Note that there is one time-offset value per patient, not one per variable. All of the variables for a given patient are inherently linked in time by their co-occurrence in an actual patient and, therefore, are not shifted in time with respect to one another.

To achieve the desired outputs, an understanding of the stratification and synchronization process is necessary. The synchronization process causes patient records to be offset from one another in time as they are joined together to form strata. A stratum formed by the joining of patients in this fashion is designated by a triple (A, B, A), which means “the record for patient B is appended to the record for patient A with an offset of Δ between the first observation time for A and the first observation time for B. The sign of Δ is positive if B's first observation occurs later than A's and negative if B's first observation occurs before A's. “Strata” then recursively play the role of “patients” in the joining process. For example, a finalized stratum might be designated this way:

(((A, B, −10.3),(C, D, −6.1), +3.2), E, +1.7)

If (A, B, −10.3) is assigned “Q,” and (C, D, −6.1) is assigned “W,” the result becomes:

((Q, W, +3.2), E, +1.7).

Further, if (Q, W, +3.2) is assigned “Z,” the finalized stratum becomes:

(Z, E, +1.7)

To begin the modeling process, each patient is placed into its own stratum. That is, patient A becomes a stratum: (A, null, 0). The patient data may be pre-conditioned before the modeling algorithm is applied. The variables should be transformed if necessary (log, square root, etc.) to stabilize variance, so that equal differences in y have equal clinical significance. Variables which are oscillatory or periodic should be replaced by variables which will fit the smoother models used here (e.g., an envelope or amplitude function, or some indication of the number of oscillatory cycles or their frequency). Noise in the data may be removed by digital filtering prior to the stratification process itself.

At each step of the process below, data for the variables within each stratum are fit to mathematical model functions. The mathematical formulation of the model functions should be chosen so that the model curves exhibit the same general shape features as the actual data. The formulations should also be chosen to have clinically-appropriate behavior when extrapolated beyond the time interval over which the actual data is fit. Thus, mathematically simple forms, such as quadratic and cubic models, may be undesirable, because they diverge to +outside of the region where they are initially fit. A linear model has been successfully employed, because the error introduced by extrapolation is acceptable.

Within the guidelines above, other model formulations can be used besides the ones described here. In the modeling process, four different mathematical formulations for models are used in succession:

Constant: y(t)=α

Linear: y(t)=α+βt

Logistic:

$$y ( t ) = a + ( b - a ) \frac{{ⅇ}^{α + β t}}{1 + {ⅇ}^{α + β t}} or ln ( - \frac{y ( t ) - a}{y ( t ) - b} ) = α + β t$$

Quadratic Logistic:

$$y ( t ) = a + ( b - a ) \frac{{ⅇ}^{α + β t + γ t}}{1 + {ⅇ}^{α + β t + γ t}} or ln ( - \frac{y ( t ) - a}{y ( t ) - b} ) = α + β t + γ {t}^{2}$$

For a given stratum, each variable ultimately fits into one of these four types of models. Fitting takes place by the following process: First, the data is “fit to a constant” by least squares. This is equivalent to simply setting a equal to the mean value of the data. The root-mean-square (RMS) deviation of the data from the model is then determined.

Second, the data is fit to a linear model, and the RMS deviation from the best-fit straight line is determined. If the RMS deviation decreases by more than a specified fraction (a parameter of the modeling process), then the linear model is accepted. Otherwise, the constant model is used.

Third, the data is fit to a logistic curve by an iterative least-squares fitting procedure. The least-squares fitting employs a Java routine developed by Steven Verrill of the U.S. Forestry Service, and is adapted from a corresponding FORTRAN software package described in R. B. Schnabel, J. E. Koontz, and B. E. Weiss, A Modular System of Algorithms for Unconstrained Minimization, Report CU-CS-240-82, Comp. Sci. Dept., University of Colorado at Boulder, 1982. The linear model is used to establish initial values for the least-squares iteration. Again the RMS deviation of the data from the curve is determined, and if the fit improves sufficiently versus the linear model, the logistic model is accepted.

Fourthly, and finally, this procedure of fitting, followed by acceptance of the new model if the fit improves sufficiently, is repeated for the quadratic logistic curve. At the end of this step, for each stratum, i.e., for each of the variables, there is a description of the type of model (i.e., constant, linear, logistic, or quadratic-logistic) and the number of parameters for the model. Constant models have one parameter, linear models have two, logistic models, four, and quadratic-logistic models, five.

The next step examines all pairs of strata. Note that pairs are “ordered pairs,” i.e., (A, B) is not equivalent to (B, A). When combining strata, no patient can appear more than once in the combination. Any pairs in which a given patient appears in both stratum A and stratum B are ignored. For each pair of strata, each variable is considered in turn. The first step, for each variable, is to determine the best values (over a suitable range) for A, such that the data for stratum B fits (in a least-squares sense) the model for stratum A when offset in time by Δ. In the present example, this is done by simply iterating the least-squares calculation at a series of equally-spaced candidate values for Δ; an alternative would be to generate a set of normal equations and solve for the best value of Δdirectly. Note that several values of Δ may give nearly the same degree of fit. In fact, if the model for patient A is constant, all values for Δ give an equivalently good fit within some range ε, which is a parameter of the modeling process. Thus, at this step in the process, Δ may be a list of values or a range, rather than a single value.

The algorithm rejects the pair of strata if the best Δ gives a fit to B's data which does not have a small enough RMS deviation from the curve of A's model. The threshold for RMS deviation is another parameter of the modeling process which one of ordinary skill in the art of statistics can set at an appropriate value depending on the nature of the analysis. If this occurs for any variable, then A and B are not considered candidates for inclusion into the same stratum during the current stage of the process. If, however, the stratum pair (A, B) yields an acceptable Δ (or set of Δ's) for all variables, then the next step is to try to reconcile these values into a single Δ for all variables. There can be only one Δ which relates stratum A and stratum B. It is not physically realistic for there to be a separate Δ for each variable, since these data stem from real observations of a real patient at a particular single point in time.

In this example, the process is to count the number of variables which are consistent with each of the values of Δ listed for the stratum pair. This results in a reduced list of Δ's which are common to all of the variables. If the reduced list contains more than one possible value for Δ, in this example the Δ with the smallest absolute value is chosen. Other options for resolving such ties, such as picking the A which gives the best overall RMS fit, may be considered.

At this point, strata A and B are merged into a new stratum, designated (A, B, Δ), i.e., the data for A and B are combined, using an offset of Δ for B's data with respect to A's. A new stratum for the combined stratum is then determined using the four model types as described above. The new stratum is “accepted” if the final RMS model fit for the combined data set is sufficiently good, as determined by comparing it against a value which is a parameter of the fitting process. If the stratum is accepted, the stratum (A, B, Δ) is added to the set of strata for evaluation.

The steps of evaluating pairs are repeated until all possible pairs have been evaluated. At that time, the list of accepted strata may be edited to remove strata below a certain size, and/or those which have not merged with another stratum during a certain number of passes. Editing may be done by some other method which permits the accumulation of large strata while reducing the time spent repetitively evaluating small strata which are “outliers” and are unlikely to merge. The pair-evaluation process is then repeated for a subsequent pass, until no new strata are formed.

As an alternative to the merging of pairs described above, an alternative clustering algorithm may be used, such as the “leader algorithm” described in J. W. Hartigan, Clustering Algorithms, John Wiley & Sons: New York, 1975, pp. 74-83. In addition, in a clinical or pharmaceutical research context, membership and position in the various strata can be correlated with clinical and genomic data.

### EXAMPLE #1

Data for modeling were taken from public files for the Diabetes Control and Complications Trial, which are available via ftp on the Internet at gcrc.umn.edu/pub/dcct/. Records for 730 patients in the Standard treatment group were used, since the patients in the Experimental treatment group were artificially “synchronized” by the intervention of the trial. For each patient, ten annual measurements were extracted for four variables (i.e., I=1 . . . 730, j=1 . . . 4, k=1 . . . 10): (a) Hemoglobin A1C (a measure of blood-glucose control); (b) Retinopathy (ETDRS scale scores from fundus photographs, the fundus being the part of an eyeball); (c) Motor Nerve Velocity; and (d) Sensory Nerve Velocity. The latter two values are measures of peripheral neuropathy, another complication of diabetes. Missing values were filled from the most recent previous available value.

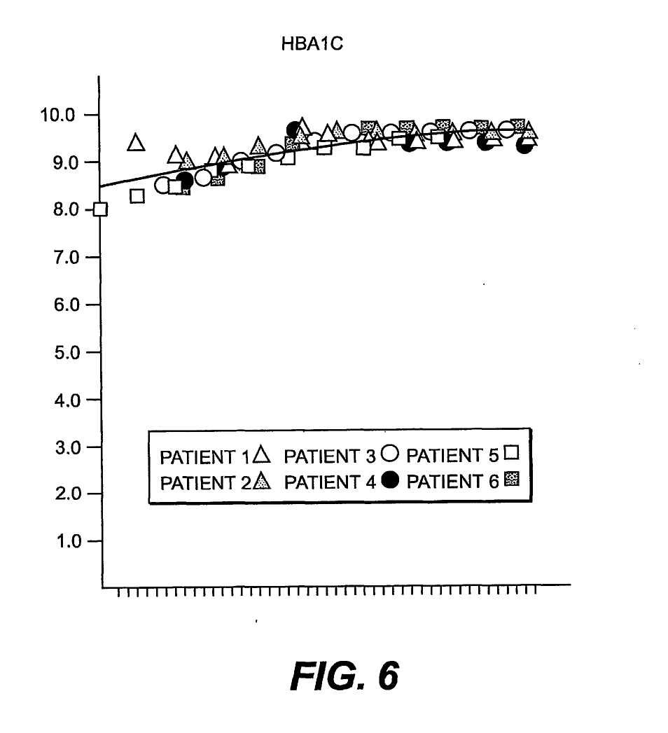

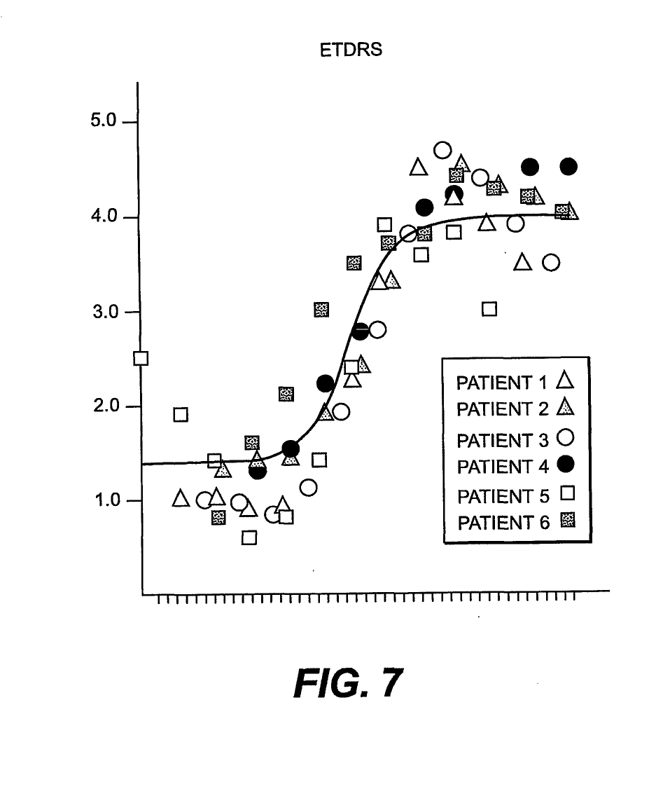

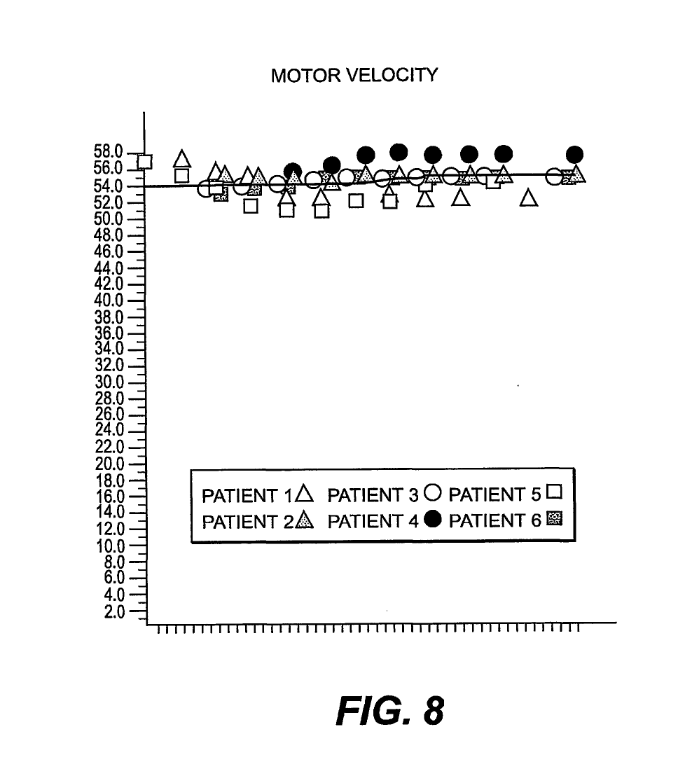

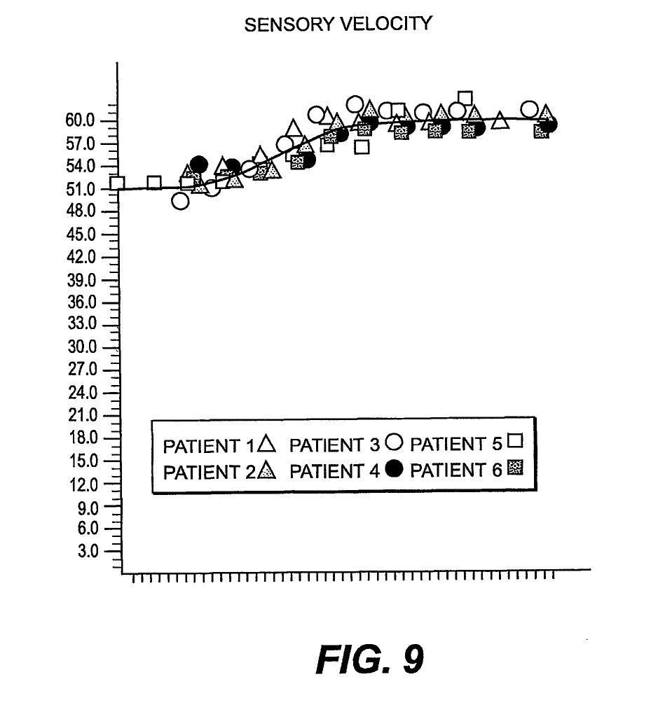

The algorithm previously described was used to cluster the patients into strata by employing time shifts to align like shaped curves. Results for the four observed variables strata are shown in FIGS. 6-9 in which: (a) FIG. 6 shows a stratum for Hemoglobin A1C, entitled “HBA1C;” (b) FIG. 7 shows a stratum for Retinopathy, entitled “ETDRS;” (c) FIG. 8 shows a stratum for Motor Nerve Velocity; and (d) FIG. 9 shows a stratum for Sensory Nerve Velocity. FIGS. 5-8 indicate how the patient records may be fit together by using an appropriate time shift. Thus, each stratum describes a picture of how a prototypical patient would progress through their disease with regard to the four variables studied. The markers in the figures indicate actual patient data points; the lines in each of FIGS. 6-9 are the best-fit modeling function for the strata.

The invention is not restricted by the description of the preferred embodiment previously set forth. Rather, the foregoing description is for exemplary purposes only and is not intended to be limiting. Accordingly, alternatives which would be obvious to one of ordinary skill in the art upon reading the description, are hereby within the scope of this invention. It will be apparent to those skilled in the art that various modifications and variations can be made to the disclosed preferred embodiments of the present invention without departing from the scope or spirit of the invention. Accordingly, it should be understood that the description of the method is for illustrative purposes only and is not limiting upon the scope of the invention, which is indicated by the following claims.

What is claimed is:

1. An information processing method for the stratification of a disease, and for the assessment of the disease's progression, comprising the steps of:
(a) recording a time series of observations for a plurality of variables obtained from a plurality of patients who share the disease;
(b) entering and storing those observations as a data set in a computer, wherein the computer performs the subsequent steps as automated computations;
(c) selecting, for subsequent analysis, a subset of the data set, wherein the subset is based on patient demographic information or prior treatment history;
(d) stratifying the disease by clustering patients into strata, wherein the strata are based on the shapes of curves which represent the progression of said observations over time;
(e) using the strata created in step (d) or step (g) to align, truncate, or extend each time series so that data points compared in step (f) correspond to a similar disease stage for all patients;
(f) for each pair of patients, comparing the aligned time series to determine a measure of the mathematical distance between them; and
(g) refining the stratification of the disease by assigning the patients to clusters based on the mathematical distances determined in step (f), such that each cluster corresponds to a stratum of the disease.

2. The method of claim 1, wherein the variables include demographic data, biochemical data, pathologic data, histological data, genetic data, or gene-expression data, or any combination thereof.

3. The method of claim 1, further comprising the step of:
(h) reducing the number of variables used in subsequent analysis, by dimensionality-reduction to eliminate or combine variables.

4. The method of claim 3, wherein the method of dimensionality-reduction is principal-components analysis or factor analysis.

5. The method of claim 1, wherein the initial estimates of disease stage for step (d) are provided by a clinician or a published clinical disease-staging algorithm.

6. The method of claim 1, wherein the mathematical distance between time series is calculated point-wise using a Euclidean metric, city-block metric, or manually-prepared lookup table.

7. The method of claim 1, wherein the cluster assignments of step (f) are interactively modified by a human operator.

8. The method of claim 1, wherein the disease stratification and progression information is subsequently used to predict the course of an individual patient's disease, by analogy to other patients at a similar stage in the same disease stratum.

9. The method of claim 1, wherein the disease stratification and progression information for a particular patient is submitted to a clinician to guide diagnosis and treatment for that patient.

10. The method of claim 1, further comprising the step of:
(h) combining the disease stratification information with genetic data, gene expression data, or biochemical data, to identify a biochemical target for drug development as therapy for a particular stratum or set of strata of the disease.

11. The method of claim 1, further comprising the step of:
(h) calculating, for each patient, an information representing the rate of change of some or all of the plurality of variables with respect to time and augmenting the data set with that information.

12. The method of claim 1, further comprising the step of:
(h) repeating steps (e) through (g), until the change in the progression and stratification estimates fall within a predetermined limit during each subsequent iteration.

13. The method of claim 1, further comprising the steps of:
(h) determining, statistically, which observed variable or variables provide the most information regarding said stratification, to develop a diagnostic marker kit for stratification of the disease under study.

14. The method of claim 1, further comprising the steps of:
(h) determining, based on the disease stratification information, lifestyle factors that are correlated with improved outcome for a particular stratum or set of strata of the disease; and
(i) recommending, based on said lifestyle factors, lifestyle changes to patients in a particular stratum or strata.

15. The method of claim 1, further comprising the additional steps of:
(h) recording a time series of observations of variables regarding an additional patient who share the disease;
(i) entering and storing those additional observations into the data set stored in the computer;
(j) estimating the stage of progression of the additional patient's disease at the time of the first observation for the additional patient;
(k) using the estimates of step (j) to align, truncate, or extend the additional patient's time series to reflect each subsequent new patient so that data points compared in step (l) correspond to a similar stage of disease for all patients;
(l) comparing, for each subsequent new patient, the aligned time series to determine a measure of the mathematical distance to the data of the patients within each cluster; and
(m) assigning the additional patient and the subsequent new patients to clusters based on the mathematical distances determined in step (l), thereby assigning them to a stratum of the disease.

16. The method of claim 15, further comprising the steps of:
(n) calculating, for the additional patient, an information representing the rate of change of some or all variables with respect to time, and augmenting the data set with that information.

17. The method of claim 15, further comprising the steps of:
(n) refining the estimate of the stage of progression of each patient's disease using the stratification information obtained in step (m).
